(19) United States
(12) Patent Application Publication
(10) Pub. No.: US 2016/0052438 A1
(43) Pub. Date: Feb. 25, 2016

(54) MODULE CONSISTING OF SUB-ASSEMBLIES AND USED AS A BASE FOR PRODUCING SPECIFIC FRAMES FOR MOTOR VEHICLE SEATS

(71) Applicant: Jean-Pierre ECKENDORFF, Claville (FR)

(72) Inventor: Jean-Pierre ECKENDORFF, Claville (FR)

(21) Appl. No.: 14/406,750

(22) PCT Filed: Jun. 7, 2012
(86) PCT No.: PCT/EP2012/060823

§ 371 Date: Aug. 3, 2015

(51) Int. Cl. B60N 2/68; B60N 2/427; B60N 2/20

(52) U.S. Cl. CPC B60N 2/682; B60N 2/20; B60N 2/427

(57) ABSTRACT

The force, exerted by the seat belt (13) attached to the top of the beam (12) attached to the tube (2) enveloping the bar (1) by making a space (3) allowing the energy absorption sleeves and their dogs to be inserted, is transmitted to the bar (1) centred in a hole (4a) of a flange (4), the bar comprising at each of its ends an arm (5) bearing on mobile abutments (6) which retransmit the force to the 2 flanges (4) each retained by their claw (4i) in the casings (17) immobilising the module on the floor of the vehicle, the force being distributed in equal parts to the 2 sides of the seat.

The use of said module results in substantial time, weight and cost savings.

The invention relates to a module, consisting of subassemblies, notably articulation and safety, used as a base to be fitted out for producing specific seat frames designed for the vehicles for which they are intended, also allowing the manufacture of seats with seat belts with 3 or 4 integrated points at the top of the backrest.

Only the seat belt is regulatory and, provided force limiters allowing its slackening are not used, only the 3rd integrated point allows the coupling of the occupant to the backrest of the seat to be ensured throughout the duration of the accident; its application is required by the Ministry of Transport and Road Safety, the “Union Technique de l'Automobile et des Cycles” and MOV'EO.

Automobile manufacturers would also like to solve the problem posed by the different types of impacts:
Front impact 20 km/h.
Front impact 56 km/h or +.
Low speed rear impact 16 km/h.
High speed rear impact 34 km/h.
Sequenced front/rear or rear/front impacts.
Side impact.
Whiplash.

The seat belts known today are slaved to devices such as pre-tensioners and force limiters the aim of which is let it slacken to limit the pressure exerted on the ribs and the shoulder blade of the occupant. As the seat belt inertia reels are not equipped with end-of-travel devices, the occupant can move away from the backrest by around 40 cm and, not being efficiently retained, hit the hard spots of the compartment and this even in the presence of inflatable airbags.

This problem is known by the few rare vehicles equipped with seats with 3rd integrated point, the seat belts being equipped with a force limiter.

The distribution of seats with 3rd integrated point is mainly limited by their weight which is 8 to 10 kg higher than a normal seat which is particularly restrictive for removable seats of people-carrier type.

This excess weight is due to their design. The moment of the beam supporting the 3rd integrated point being mainly retained by the mechanism located on same side, the majority of the force is transferred to this one side; as the seat is deformed, it must be reinforced and therefore made heavier.

The seats such as manufactured today comprise a seat pan, a backrest and at least 1 but often 2 mechanisms ensuring the link and the articulation of the backrest on the seat pan.

The vehicles proposed by the manufacturers are designed to accommodate any passenger and, notably for the driver's seat, plan for no maximum or minimum limits for the weight of the occupant.

A very small size vehicle manufactured according to the regulations in force must therefore be able to accommodate a corpulent person, 120 kg, whereas a small size person, 45 kg, may find herself/himself in a top-range vehicle.

A seat is broken down into 2 main parts: the upholstery ensuring appearance and comfort aspects, designed especially vehicle by vehicle, and the frame ensuring resistance to forces.

A complete frame must therefore be designed to accommodate any occupant in any vehicle.

However, the manufacture of such a frame cannot be conceived on account of the diversity of the vehicles and would not solve the problem of the seat dimensions, notably in width, and its design according to its location on the 1st, 2nd or 3rd row whilst taking into account the rail, raising and other options.

The seat with 3rd integrated point allows the automobile manufacturers to be freed from the anchoring points on the bodywork to be able to redesign the compartment and notably eliminate the uprights located between the front and rear doors with the advantage of better comfort and improved safety for the occupants.

The currently known floor attachment principles for removable seats lead to an increase in weight and include 4 anchoring points. For removable seats without rails, it seems possible to limit their attachment to 3 points simplifying the manufacture of the floor.

An approved module representing the base for a new seat design, valid irrespective of their location on 1st, 2nd or 3rd row, simplifies the calculations, allows substantial gains in cost, time and weight and the manufacture of prototypes.

To solve the various problems posed, a module can be designed consisting of subassemblies with all the functions required for the transmission of the force exerted by the seat belt, from the top of the backrest to the attachment to the floor, whilst leaving the vehicle and equipment manufacturers free with the definition of the complete frame provided according to the vehicle concerned.

The module consisting of the subassemblies comprising it notably comprises:
A beam equipped at upper part with the 3rd integrated point of the seat belt and at its lower part with attachment means to a stiff crossbar.
A crossbar acting as support and articulation for the backrest.
Two flanges accommodating, in a hole, the articulation of the bar and, on their sides, means for immobilising said bar.
Two side beams acting as base for the seat pan.
Means for attaching the module to the floor.
A crossmember attaching the 2 flanges.

The crossbar must not encroach into the comfort clearance corresponding to the minimum distance to be provided between the occupant of the seat and a hard spot.

Two solutions can be considered to adjust the horizontal offset required:
The axis of the bar extends from the backrest hinge axis. The beam is offset from the front face of the bar and connected by 2 flanges ensuring the bar/beam link.
The axis of the bar is in addition offset in relation to the axis of the backrest hinge mechanism and connected by the bar/mechanism flanges. This solution in addition to the adjustment of the horizontal offset also allows the installation height of the bar to be adjusted.

The stiff crossbar, free to rotate and comprising immobilisation arms at each of its ends, will accommodate the uprights of the backrest and will allow the angular position to be modified in a controlled manner. The bar can be used alone for a normal seat without 3rd integrated point, its stiffness allowing the rear impact case and the luggage impact case, if the height is appropriate, to be satisfied.

Advantageously, an energy absorption mechanism can be used to replace this bar as described in the French patents FR2897019 and FR2949397 in the name of the same inventor or as described below in this patent application.

On each side of the seat, a flange associated with a side beam will replace a part of the side of the seat pan; at least 1 of these flanges, but preferably the 2, is/are equipped with a mechanism located indifferently on one or the other or simultaneously on the 2 faces to ensure the immobilisation of the backrest.

These flanges, at the backrest hinge point, include a hole allowing the centering of the bar, free to rotate at each of its ends, and preferentially cylindrical.

This bar is equipped with at least 1, but preferably 2, immobilisation arms attached at each of its ends and bearing on 1 side of their respective flanges; an abutment attached to the bar, bearing on the other flange, ensures its axial immobilisation. The abutment can also be made by the end of a sleeve or a tube.

The immobilisation arm is slightly offset from the flange; only the central part is in contact by its outside contour offset by a stamped dome.

A play take-up lug integrated into the immobilisation arm comprises a bearing surface on an elastic abutment.

To restrain the displacement of the backrest forwards, a retractable abutment attached to the flange by a hinge pin comprises at least one reception surface for the force allowing the immobilisation arm to be placed in contact. It also comprises at least a step ensuring its correct bearing position under the end of the arm.

An unlocking rod, welded to the end of the hinge pin of the abutment protruding from the opposite face of the flange allows the control of the retractable abutment and the axial retention of these 2 parts.

This rod supports an unlocking handle allowing the 2 abutments to be actuated simultaneously. A control by cable can also be considered.

A tension spring is attached by one of its ends to the rod, its other end being attached to the flange, thus allowing the step to be firmly maintained in contact on the front face of the arm to avoid unwanted unlocking.

A fixed abutment, attached to the flange, limits the displacement of the rod and therefore of the retractable abutment allowing the spring to maintain all of the parts in tension to avoid vibrations when the backrest is placed flat.

The position of this fixed abutment determines the position of the retractable abutment to obtain memorised automatic blocking when the backrest is placed back in its normal position, without having to operate the unlocking handle.

To restrain the displacement of the backrest rearwards, a fixed abutment attached to the flange comprises a reception surface for the force on which the arm bears.

To obtain correct operation of the mechanism and to be certain of the correct locking of the retractable abutment, the rear fixed abutment must be offset which causes play in the backrest.

To avoid this disturbance, the arm is equipped with a play take-up lug coming into contact with an elastic element which automatically holds it permanently in contact with the retractable abutment as soon as it is locked.

A return spring similar to those used with known discontinuous mechanisms can also be installed to take up the play at least on one side.

A known adjustment mechanism, of continuous or discontinuous type, can also be used, or one of its sides can be directly stamped in the flange. The other side will be arranged and will have a shape compatible with its connection to the bar.

This solution allows the seat to be made in 2 separate backrest/seat pan assemblies.

The synchronisation of the 2 mechanisms can be done, either by a rod passing inside the bar if it is on the same axis, or by a formed crossmember in case of axial offset of the bar/mechanisms.

To reinforce the stiffness of the flanges, a flanged fold will be made on the sections of their contours requiring it, notably at the lower section for the attachment, for example, to rails.

The flat section of the flange can also be extended by an attachment hook consisting of a finger extended by a claw which hooks from the front to the rear on a retaining pin attached to a casing incorporated into the floor. The claw is separated from the finger by a horizontal slot, larger at the inlet, the bottom of which is semi-circular to allow the centering of the hook on the retaining pin, thus ensuring the heightwise and longitudinal positioning. The tangent of the retention pin is separated from the inner forward face of the casing by a radius the length of which is maximum at the horizontal and will then decrease in order to form the outside of the claw. The front face of the finger will culminate in a manner perpendicular to the radius at its end opposite the pin and its surface will bear with low friction on the front inner face of the casing to avoid the axial play and retain the force of the front impact.

For a removable seat with rails, this type of hook can be added under the rails to ensure their attachment.

In the case described above, the hooks are incorporated into the rear part of the seat which is engaged first and then tilted forwards to engage the retention means of known types such as ball locking provided at the front of the seat. For removable seats without rails, a single front retention means seems sufficient which can be placed, for example, in the centre of the anti-submarining crossmember, the front feet of the seat descending as far down as possible without hindering the engagement of the locking.

In the case where the seat is engaged via the front the backrest placed flat on the seat pan, in order to maintain it vertically bearing on the backrest of the 1st row, a variant with vertical claw engaged from bottom to top will be used. In this case, the finger supporting the claw will be retained by a segment allowing its articulation between the pin and a casing of semi-circular form.

An embodiment variant provides for at least one hinge lug attached under the front face of the seat.

During the handling, the seat pan is in vertical position together with the end of the lug which, during positioning, engages between a bearing abutment ensuring its vertical position and a retention abutment ensuring its immobilisation.

To place the seat in its utilisation position, it suffices to slightly raise it to allow the lug to pass above the retention abutment and to tilt it towards the rear until it automatically locks onto the floor.

Another solution consists in incorporating a lock into a rib acting as stiffener for the lug, the end of the lock being engaged simultaneously in the end of the lug and in a housing made in the bearing abutment.

To meet the safety demands concerning both the coupling of the occupant to the backrest and a mechanism allowing the problem posed by the various impacts to be solved, the bar must be replaced by an energy absorption mechanism.

The various values, notably the speeds, forces and angles are given below only as an example to make understanding easier.

This type of mechanism must meet the requirements of the front impact at 56 km/h for 3,400 Nm and the rear impact at 34 km/h for 2,000 Nm, transfer the force of the 3rd point in equal parts to the 2 sides of the seat and simplify as far as possible the making of the energy absorption mechanism.

An outer tube, provided to accommodate the beam supporting the 3rd integrated point and the upright allowing the backrest to be comprised, will envelop in a concentric manner the central bar receiving the force that it will transmit by 2 arms attached to each of its ends to the 2 flanges. A space will be made between the inside diameter of the tube and the outside diameter of the bar thus allowing all the energy absorption bars and their modulation and end-of-travel dogs to be inserted in line whilst avoiding their radial distortion over their complete length and ensuring the centering of the assembly.

Several possibilities of dog and sleeve arrangements allowing the construction of various mechanisms are described below as an example in a non-restrictive manner, all other arrangements entering into the scope of the invention.

In all the cases, a 1st energy absorption sleeve placed at any end of the bar is welded to it by its end located at seat centre side, and welded by its other end to the end of the tube to securely attach the backrest to the bar, limit the length of the elastic parts as far as possible and allow an immediate increase in load whilst reducing the elastic recovery.

By welding a 2nd identical sleeve in a symmetrical manner to the other end of the bar, a simplified mechanism is designed with same resistance for the front and rear impacts distributing the force in equal parts to the 2 sides.

An increase in load due to the different stressing of the 2nd sleeve depends on the elasticity of the tube separating it from the beam.

A variant to this first solution consists in extending the second sleeve by a modulation dog allowing the rear impact to be differentiated from the front impact. For the front impact, the teeth of the dog will be in contact so that the 2nd sleeve will be driven at the same time as the 1st one; however, for a rear impact, a space of 20° for example will separate the teeth so that only the 1st sleeve will work, the 2nd sleeve operating only beyond 20°, the mobile part of the dog is attached to the sleeve and the fixed part of the bar.

For this mechanism, to transfer the forces in equal parts, the 1st sleeve must be extended by the length of the dog.

To limit the displacement of the occupant of the seat, it is desirable to provide an end-of-travel dog limiting for example the distance to 50° for a front impact and to 30° for a rear impact.

In order to transfer this force in equal part to the 2 sides, the end-of-travel dog must be extended to transfer the force substantially to the centre of the bar.

The end of travel can be either an immediate stop of the dog at the angle planned or a damped stop by a 3rd energy absorption sleeve the retention force of which will be slightly lower than the 1,150 Nm strength of the dog.

In the case of the damped impact, the teeth of the dog will be in contact at an angle lower than that of the immediate stop allowing the sleeve to anticipate to absorb the energy between these 2 angles.

The sleeves playing the role of a fuse balance, even during load increase, the force exerted on each end of the bar allowing it to be limited to 1,700 Nm.

To solve the front impact case of 20 km/h and the low speed rear impact case of 16 km/h, the force must be distributed on 3 sleeves and at least 3 but preferentially 4 dogs, that is 2 modulation dogs and 2 end-of-travel dogs, thus allowing the end-of-travel stop strength to be doubled bringing it to 2,300 Nm and the forces to be distributed on the 2 sides. The extension of only one or of the 2 end-of-travel dogs by an end-of-travel energy absorption sleeve allowing a damped stop is also planned.

The 1st sleeve ensuring the immobilisation of the backrest will have a strength of 1,000 Nm. A 3rd sleeve also with a strength of 1,000 Nm will enter into action for example at 6° for a front impact, at the same time as the 2nd 1,400 Nm sleeve the modulation dog of which is also offset by 6°, this representing a total strength for the mechanism of 3,400 Nm to which the end of travel of 2,300 Nm must be added, that is a total of 5,700 Nm.

For the rear impact, the 3rd sleeve control dog is offset by 10°, that of the 2nd sleeve by 20°, the end of travel being 30°; this corresponds to a progressive strength of the energy absorption mechanism of 1,000 Nm from 0 to 10°, 2,000 Nm from 10 to 20° and 3,400 Nm from 20 to 30°, completed by the 2 ends-of-travel provided in this mechanism, that is a total strength of 5,700 Nm corresponding to the request for the 3 Euro-NCAP “Low-Medium-High” tests.

A last point concerns the strength of the floor currently planned in cars to support a force of around 3,400 Nm corresponding to the regulations.

It is possible to ensure efficient protection by using a 1st 1,000 Nm sleeve which will act alone for the protection of the 20 km/h front impact and the 16 km/h rear impact.

A 2nd 1,000 Nm sleeve will enter into service at 6° for the front impact and −10° for the rear impact.

A 3rd 1,400 Nm sleeve will enter into service at 6° for the front impact and −20° for the rear impact.

Also, the increase in load and the elastic recovery of the tube between the beam supporting the 3rd integrated point and its connection to the various sleeves must be taken into account.

The dogs will be obtained directly by laser cutting in a single tube supporting the 2 sections of the dog in the form of a complete subassembly easy to produce and insert into the structure, these sections being indexed and linked to each other by breakable points to differentiate between rear impact and front impact and limit the forward/rearward travels of the backrest.

One or more dogs associated with one or more sleeves comprise a subassembly. During their manufacture, these subassemblies are separated by a laser cut allowing an embossed or hollow indexation mark to be made in relation to the cut in order to avoid assembly errors.

The sleeves, used alone, are welded by one of their ends to the bar, the other end being welded to the tube.

The end-of-travel dogs, used alone, are also welded by one of their ends to the bar, the other end being welded to the tube.

For composite subassemblies comprising a sleeve associated with a modulation dog, the dog can be welded to the bar and the sleeve to the tube or vice versa.

For a sleeve associated with 2 dogs, the 2 dogs will be preferentially grouped at one end so that there will be only one induction hardened area, the sleeve at the other end being in the extension of the modulation dog. This subassembly will be welded to the bar by each of its ends and connected to the tube between the 2 dogs.

For 2 sleeves associated with 2 dogs, the 2 dogs will be preferentially grouped in the centre and enclosed by 2 sleeves. This subassembly will be welded to the bar by each of the ends of the sleeves and connected to the tube between the 2 dogs.

The tube can consist of a single part but, according to certain applications, intermediary welds are required between its 2 ends.

In this case, 2 solutions can be considered: either conserve it in a single part and make perforations allowing plug welds to be made on the sleeves or the dogs, or cut it into several elements and make circular weld beads.

Also, the increase in load and the elastic recovery of the tube between the beam supporting the 3rd integrated point and its connection to the 2nd sleeve must be taken into account.

The regulatory seat belt with 3rd integrated point can be mounted in several ways:
Conventional installation with inertia reel attached in the seat pan vertical to the beam, for example by the crossmember connecting the 2 flanges, the belt rising up at rear part of the backrest and passing by a guide at the upper part of the backrest, the fixed point being located beside the inertia reel. Simplified installation, with fixed point located at the upper part of the backrest, the inertia reel fixed to the flange acting on the lap part of the belt.
The beam supporting the 3rd integrated point can be installed on the centre side of the vehicle, in so-called reversed manner, allowing bilateral protection to be ensured in the case of lateral inflatable airbags.

The regulatory seat belt can be completed by a 4th point located symmetrically on the other side of the headrest to comprise a harness. This device in no way modifies the existing regulatory 3-point seat belt but comprises an addition.

The harness consists of a strap, identical to that of the regulatory seat belt attached to the top of the backrest and equipped at its other end with a length adjustment device extended by a buckle identical to that of the regulatory seat belt and attached to the opposite flange.

A safety device can be provided preventing the click locking of the buckle of the harness if the buckle of the regulatory seat belt is not locked.

A crossmember located at the lower part of the flanges will ensure their attachment and will allow the fastening of the support of the seat pan upholstery and the attachment support of the seat belt inertia reel.

If necessary, the ends of said crossmember can be fitted into an orifice made in each end of the side beams of the frame of the seat pan which in addition will comprise 2 slots allowing the fitting and the attachment of the flange.

Different embodiment examples of a motor vehicle seat frame module consisting of an articulation subassembly and of a safety subassembly according to the invention will be described below, making reference to the appended drawings on which:

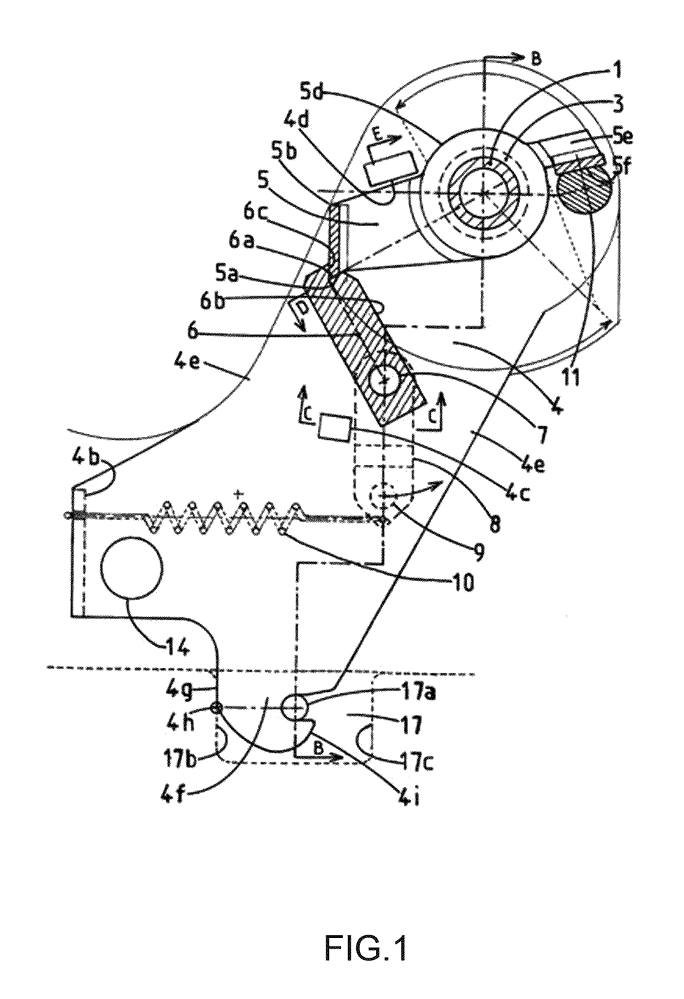

FIG. 1 shows, in vehicle movement direction, from the right to the left, a front view according to the invention of the left seat pan flange of an LH seat equipped with the bar immobilisation mechanism, the crossmember and the attachment hook.

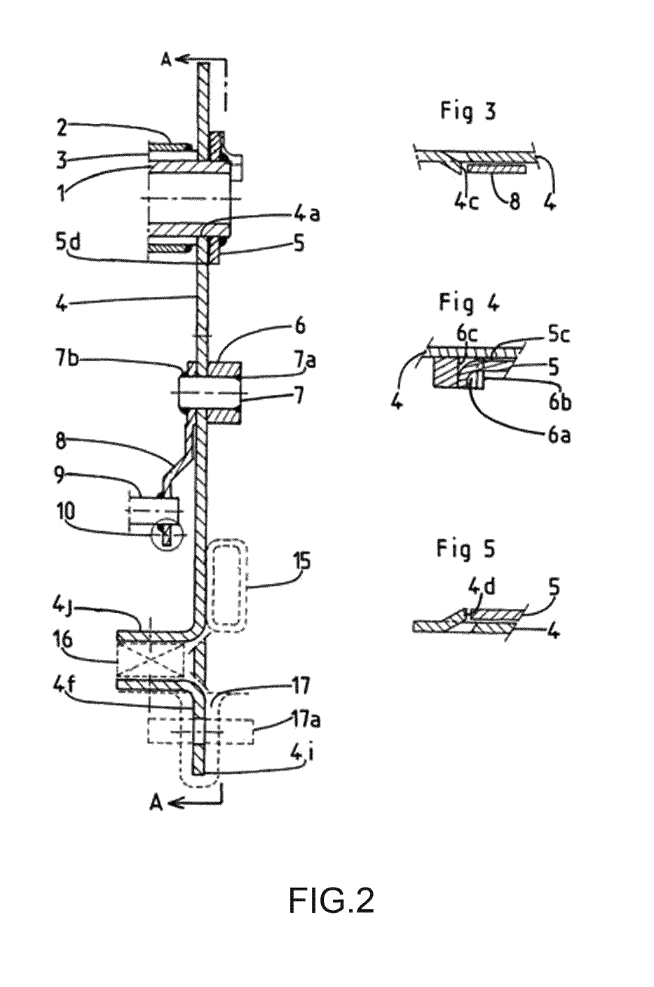

FIG. 2 shows, by offset cross sections, the flange equipped with the bar, the immobilisation mechanism and the attachment.

FIG. 3 shows a cross-sectional view of the end-of-travel abutment of the retractable abutment control rod.

FIG. 4 shows a cross-sectional view of the end of the arm bearing on the retractable abutment, itself bearing on its step.

FIG. 5 shows a cross-sectional view of the arm retention abutment defining the maximum rear position of the backrest.

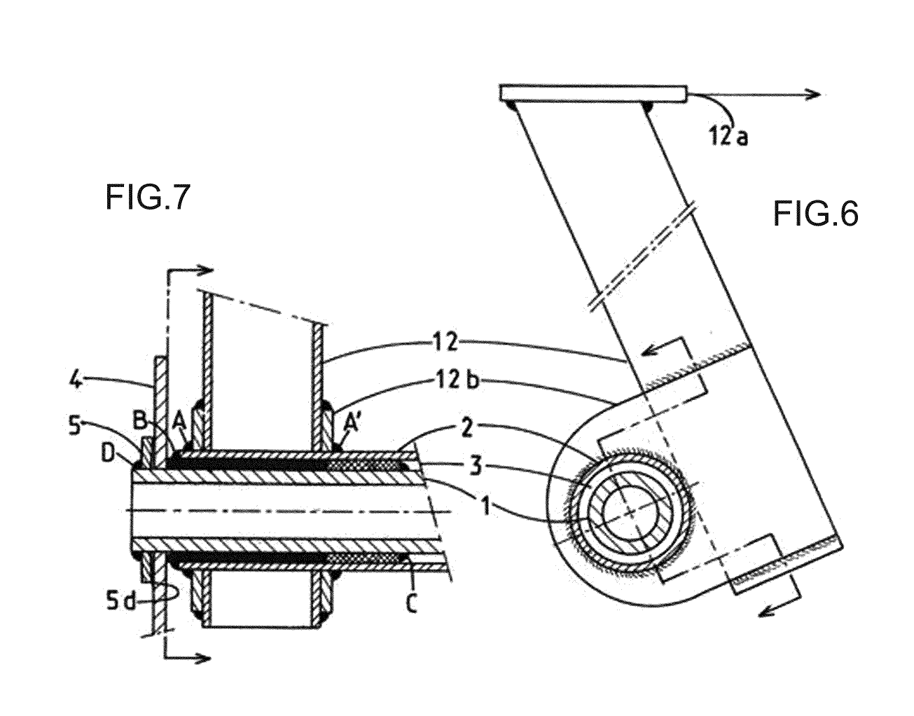

FIG. 6 shows a side view of the attachment of the 2 assembly flanges of the beam supporting the 3rd integrated point on the tube of the energy absorption mechanism.

FIG. 7 shows a longitudinal view of the 2 beam/tube assembly flanges, the flange being immobilised axially between the end of the sleeve acting as abutment and the curved arm closing the assembly.

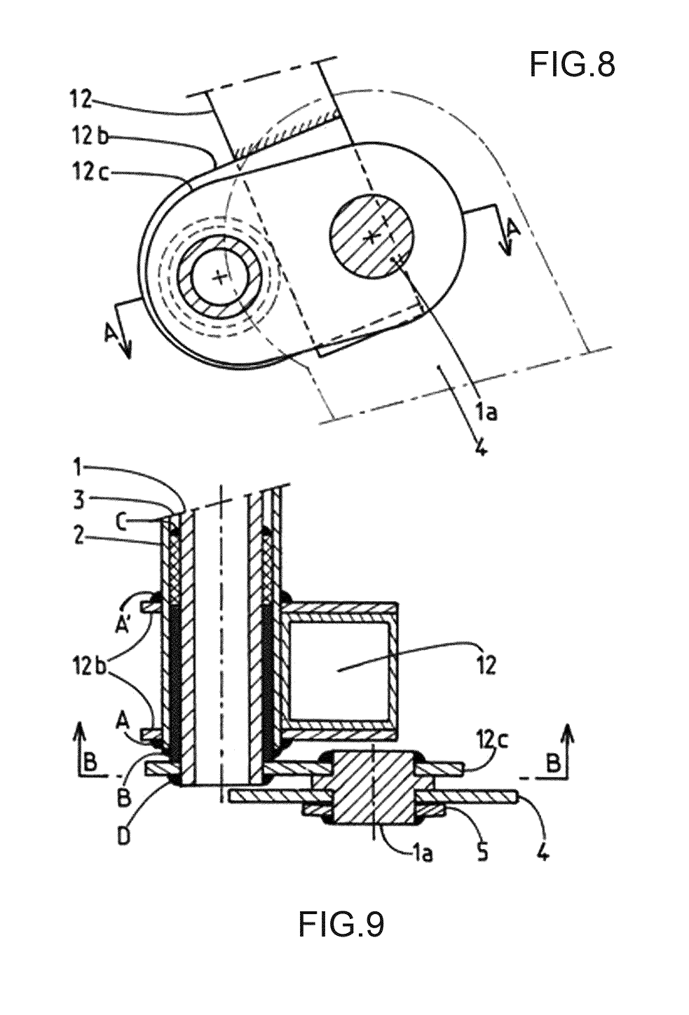

FIG. 8 shows a side view of the attachment by flanges of the bar on the pivot and of the beam on the tube.

FIG. 9 shows a longitudinal cross-sectional view of the bar/pivot and beam/tube assembly flanges.

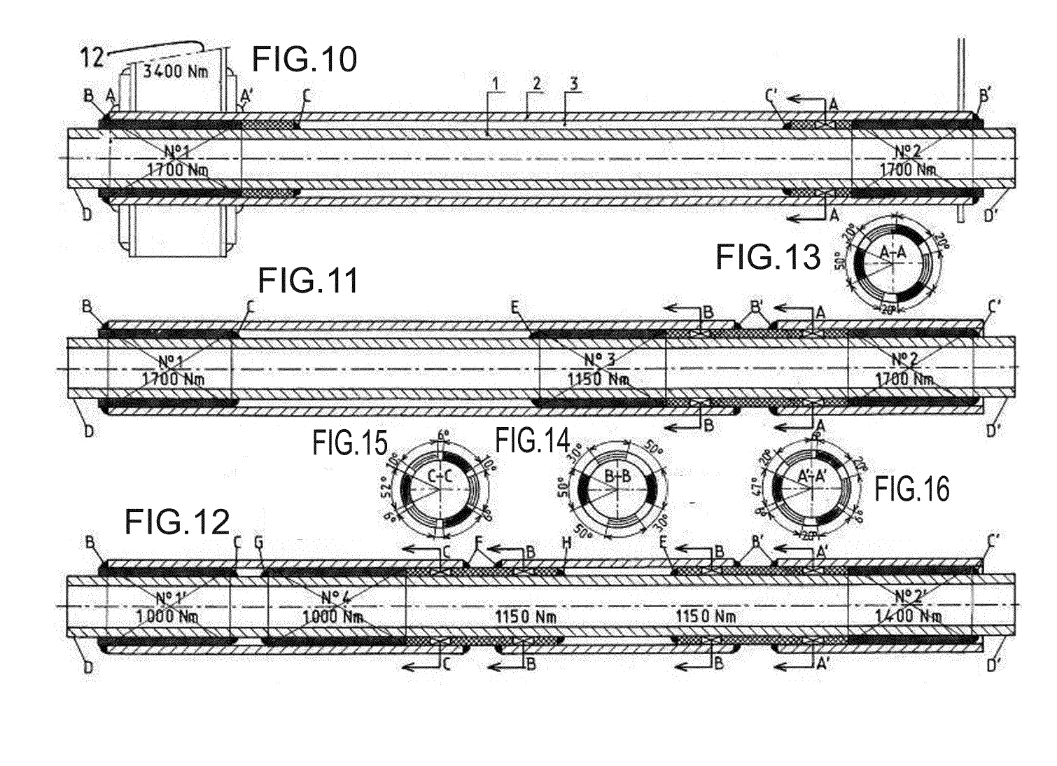

FIG. 10 shows a longitudinal cross-sectional view of a mechanism comprising 1 backrest immobilisation sleeve and 1 sleeve associated with its rear impact modulation dog.

FIG. 11 shows a variant of FIG. 10 completed by a front/rear end-of-travel dog extended either by a sleeve allowing a damped stop or by a section also hardened allowing an immediate stop.

FIG. 12 shows a longitudinal cross-sectional view of a mechanism comprising 1 backrest immobilisation sleeve, 2 sleeves associated with their front/rear impact modulation dogs and 2 end-of-travel dogs allowing an immediate stop or possibly extended by a sleeve not shown allowing a damped stop.

FIG. 13 shows an axial cross-sectional view of the rear impact modulation dog A-A.

FIG. 14 shows an axial cross-sectional view of the end-of-travel dogs B-B.

FIG. 15 shows an axial cross-sectional view of the front and rear impact modulation dog C-C.

FIG. 16 shows an axial cross-sectional view of the front and rear impact modulation dog A′-A′.

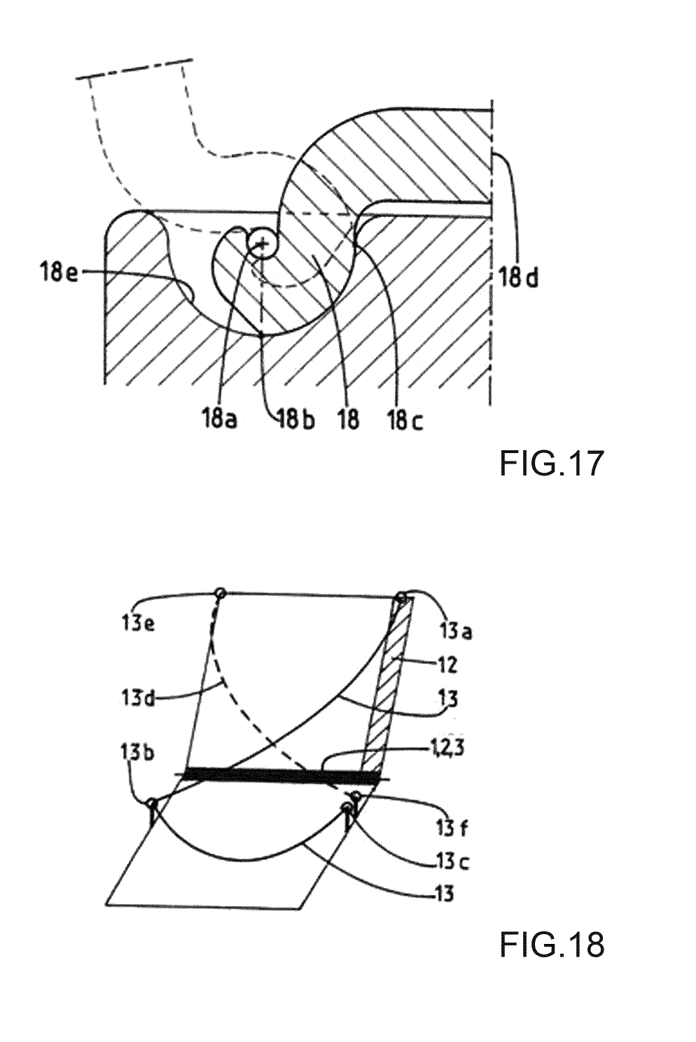

FIG. 17 shows a longitudinal cross-sectional view of a vertical claw hook oriented from bottom to top.

FIG. 18 shows a perspective view of the seat belts with 3rd and 4th integrated points.

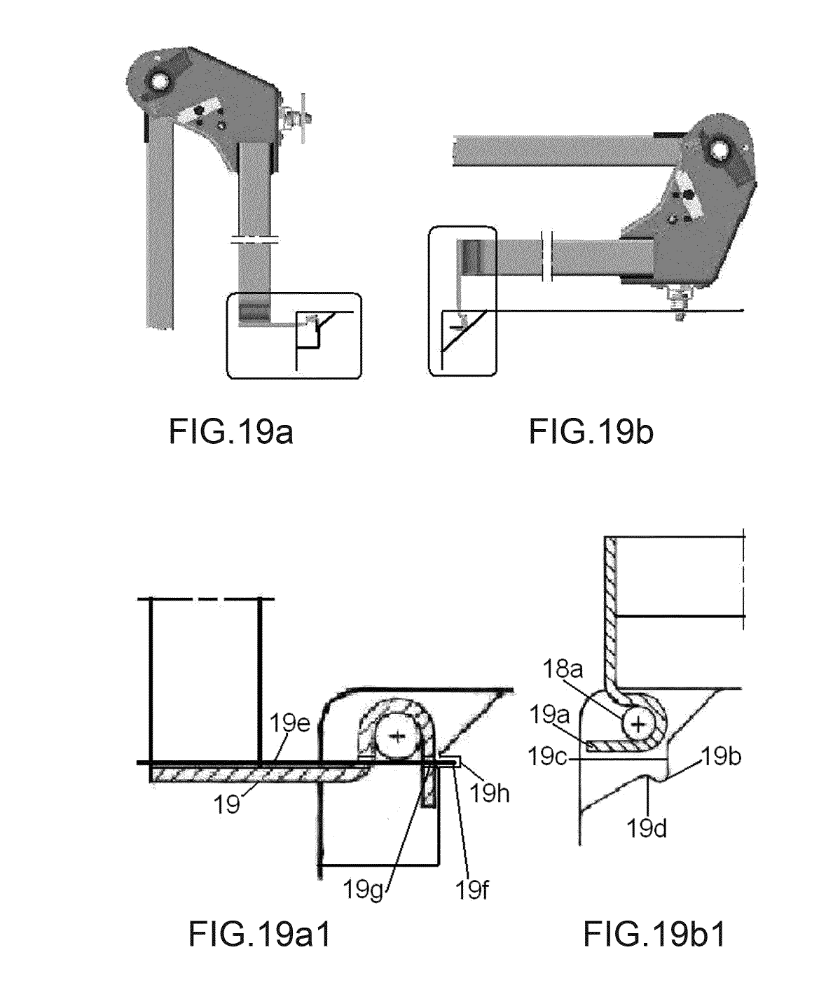

FIGS. 19a, 19a1, 19b and 19b1 show side and detailed views of a hinge lug.

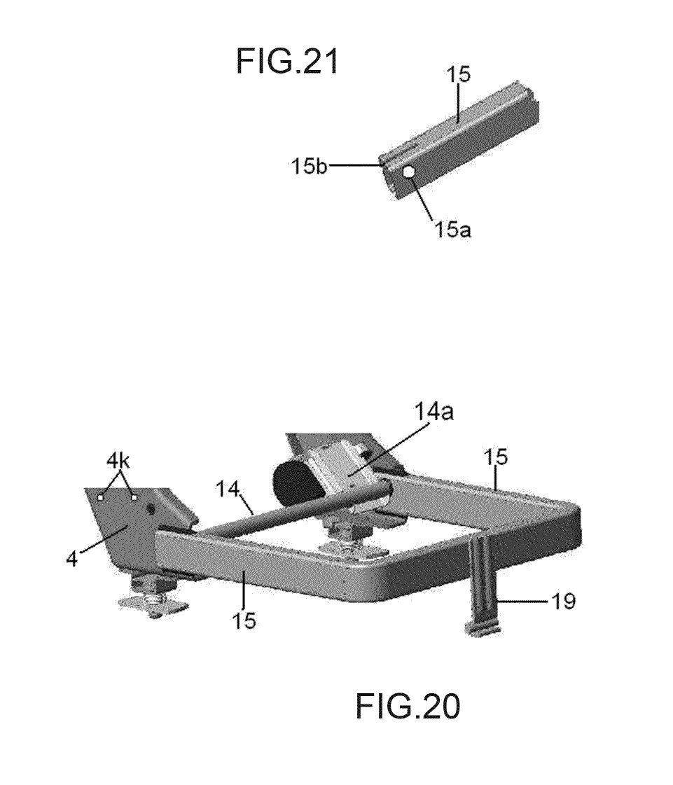

FIG. 20 shows a perspective view of the seat pan subassembly.

FIG. 21 shows a perspective view of the end of a side beam.

The module is designed to transmit to the floor of the vehicle the force received at the top of the backrest.

FIGS. 1 and 2 show a flange 4 on which the parts comprising the backrest immobilisation mechanism are mounted. Flange 4 produced in a single stamping/cutting operation comprises a hole 4a allowing the centering of the bar, a spring attachment fold 4b, a rod abutment 4c, a backrest rear position retaining abutment 4d, lateral stiffening flanged folds 4e, a hook 4f comprising a finger bearing face 4g, an end of a radius 4h, a claw 4i, a rail or floor attachment fold 4j, the attachments of an elastic abutment 11, buckle points 13b and fixed point 13c of the seat belt, a crossmember 14 and seat pan side beams 15.

The hook 4f, shown in closed position, is immobilised in a casing 17, incorporated into the floor of the vehicle, between a seat retention pin 17a and a front bearing face 17b, which determines the maximum length of a radius perpendicular to the face 17b abutting at 4h, the length of which is continually decreasing to give to claw 4i a form allowing easy installation and removal of the seat.

An immobilisation arm 5 produced in a single stamping/cutting operation comprises a front face 5a 5b obtained by folding. This face comprises at lower part a bearing surface 5a bearing at 6a on a retractable abutment 6, an upper part 5b bears on the face 6b of the retractable abutment to initiate its displacement which will be continued until the locking by the permanent sliding of the front surface. The face 5c is offset from the face of the flange 4 whereas only the circular contour 5d of the centre part is in contact with the flange.

A lug 5e diametrically opposite the immobilisation arm allows the take-up of the play by contact of the bearing surface 5f on the elastic abutment 11.

The retractable abutment 6 made in a single operation on dedicated machine is obtained from sections cut from a pretreated steel bar. The bearing face 6a receives the force 5a of the arm; the face 6b allows its angular displacement for locking; face 6c of the step places it in contact in correct position on the front face of the arm.

In an offset manner, several bearing faces 6a can be made associated with their step 6c to obtain several backrest positions.

A press fitted pin 7 is welded at 7a onto the retractable abutment 6 to allow its articulation in the hole of the flange 4 and welded at 7b to the rod 8 to index it in relation to the abutment 6 and close the assembly.

A rod 8 produced in a single stamping/cutting operation comprises the holes allowing its attachment to pin 7, the attachment of a handle 9 and the attachment of the return spring 10.

A handle 9 allows the simultaneous unlocking of the 2 retractable abutments 6.

A tension spring 10 ensures permanent and automatic return of the retractable abutment 6 and allows memorised locking of the backrest utilisation position.

An elastic abutment 11 takes up the play of the backrest.

A strengthening crossmember 14 of the two flanges allows their relative angular indexation in relation to each other and the attachment of the seat pan upholstery support.

FIG. 3 shows a cross-sectional view of the abutment 4c in locked position of the retractable abutment 6.

FIG. 4 shows a top view of the end of the arm 5 bearing on a surface 6a of the retractable abutment.

FIG. 5 shows a cross-sectional view of the backrest rear position retention abutment 4d.

FIG. 6 shows a side view of the beam 12 equipped with the third integrated point 12a and assembly flanges 12b allowing its attachment to the tube 2.

FIG. 7 shows a longitudinal cross-sectional view of the assembly of FIG. 6, the circular contour bearing surface 5d of the arm 5 on the flange 4 axially immobilised by the sleeve bearing on the other face.

FIG. 8 shows a side view of the beam 12 and the junction flanges 12b with the tube 2, the junction flanges 12c of a bar 1 with the pivot 1a of a backrest immobilisation mechanism.

FIG. 9 shows a top view of a longitudinal cross-sectional view of FIG. 8 and the pivot.

FIGS. 10, 11 and 12 show longitudinal cross-sectional views (seat rear view) of the energy absorption mechanisms consisting of a stiff centre bar 1 free to rotate in the holes 4a of the flanges 4 and of a tube 2 supporting the beam 12 which transmits to it at A/A′ the force of 3,400 Nm exerted on its top 12a by the end 13a of the regulatory seat belt 13.

A space 3 formed between the outside of the bar 1 and the inside of the tube 2 is provided to accommodate all of the energy absorption sleeves and the dogs which ensure the centering and are found thus radially maintained over their complete length.

A sleeve No. 1 is welded by an end at B to the end of the tube 2 and by its other end at C to the bar 1, central side of the seat, to ensure the immobilisation of the tube 2 and of the beam 12 and therefore of the backrest, but this has the disadvantage of transferring the force to this side alone.

By installing in a symmetrical manner a sleeve No. 2 on the other end of the bar, it is possible to make a simplified mechanism, not shown, with the same strength of 3,400 Nm for the front impact and the rear impact and transferring the force in equal parts to each side.

FIG. 10 shows a mechanism comprising the sleeve No. 1 and, in addition, a sleeve No. 2 associated with a rear impact modulation dog A-A.

For the front impact, the teeth of the dog A-A are by construction in contact. The force of 3,400 Nm transmitted by the beam 12 to the assembly flanges 12b or 12c is distributed between two circuits. The 1st one is AB>C>DD′, the 2nd one is A′>B′>A-A>C′>D′D. The distribution of the force in two equal parts of 1,700 Nm on points D and D′ will be done only after the stressing of the section A′/B′ of the tube 2 when the sleeve No. 2 begins to plastify.

The sleeves playing the role of a fuse limit the maximum force received by each of the flanges during the increase in load to 1,700 Nm.

For the rear impact, the distribution of the two circuits is the same, but an offset of 20° exists between the teeth of dog A-A; during this period, the sleeve No. 1 works alone retaining 1,700 Nm which will then pass to 3,400 Nm when the sleeve No. 2 enters into action at 20°.

FIG. 11 shows a variant of FIG. 10 comprising, in addition, an end-of-travel dog B-B for the front and rear impacts with a stopping capacity of 1,150 Nm.

In this case, the force transmitted by the section A′/B′ increases from 1,700 Nm to 2,850 Nm and a 3rd circuit B′>B-B>E>D-D′ is established.

In the case of an immediate stop at 50° for the front impact and 30° for the rear impact, the dog will be extended by a section of tube (corresponding to the sleeve) also hardened and welded at a point E to the bar distributing all of the forces in equal parts to D and D′.

In the damped shock case, the teeth of the dog B-B will be in contact at an angle lower than that of the immediate stop allowing sleeve No. 3 to anticipate for the absorption of the energy between these two angles without exceeding the angle of the immediate stop.

A mechanism not shown but of same design as mechanism 11, apart from the strength of the sleeves and the angles of the dogs, allows the seats with 3rd integrated point to be installed in existing cars without reinforcing the floor.

The 1,000 Nm sleeve No. 1 will act alone for the protection against the 20 km/h front impact and the 16 km/h rear impact.

The 1,000 Nm sleeve No. 2 will enter into service at 6° for the front impact and at −10° for the rear impact.

The 1,400 Nm sleeve No. 3 will enter into service at 6° for the front impact and at −20° for the rear impact.

This arrangement represents therefore a protection for:
1,000 Nm front impact from 0 to 6° and 3,400 Nm beyond this
1,000 Nm rear impact from 0 to −10°, 2,000 Nm from −10 to −20° and 3,400 Nm beyond this.

FIG. 12 shows a mechanism designed for low impacts and the retention force of a sleeve No. 1 brought to 1,000 Nm passes via circuit AB>C>DD′ to immobilise the backrest.

So that initially this sleeve will be the only one working, the modulation dogs A′-A′ and C-C and the two end-of-travel dogs B-B must not be in contact for the low impact.

For the front impact, the teeth of the dogs C-C and A′-A′ will be in contact at 6° simultaneously placing in service the sleeves No. 4 and No. 2′ to contain the force of 3,400 Nm.

For the rear impact, the teeth of dog C-C will be in contact at 10° placing in service the 1,000 Nm sleeve No. 4 thus allowing, from this angle and up to 20°, the retention of the medium impact at 2,000 Nm followed by the placing in contact at 20° of the teeth of the dog A′-A′ placing in service the 1,400 Nm sleeve No. 2′ which allows, from this angle, the high impact at 3,400 Nm to be contained up to an immediate end-of-travel abutment at 30° or a damped stop by sleeves attached to the two dogs B-B.

FIG. 13 shows an axial cross-sectional view of rear impact modulation dog A-A. For the front impact, the teeth of the mobile part of the dog attached to sleeve No. 2 are in contact with the teeth of the fixed part attached to the bar to allow the two sleeves to be driven simultaneously; however, for the rear impact, a space of 20° is reserved between the teeth so that only sleeve No. 1 will work from 0 to 20°, sleeve No. 2 entering into service only from this angle.

FIG. 14 shows an axial cross-sectional view of the end-of-travel dogs B-B designed for the front impact at 50° and for the rear impact at 30°.

FIG. 15 shows an axial cross-sectional view of the front and rear impact modulation dog C-C. For the front impact, to initially leave sleeve No. 1′ to work alone, a space of 6° is provided between the teeth of the dog; for the rear impact, a space of 10° is provided from which the sleeve No. 4 will enter into service.

FIG. 16 shows an axial cross-sectional view of the front and rear impact modulation dog A′-A′. For the front impact, to initially leave sleeve No. 1′ to work alone, a space of 6° is provided, angle from which sleeves No. 4 and 2′ will enter into service. For the rear impact, the dog No. 2′ will enter into service at 20°.

FIG. 17 shows a longitudinal cross-sectional view of a vertical claw hook oriented from bottom to top. The hook 18 equipped with an arm 18d allowing its attachment to the seat pan is maintained free to rotate without play between a pin 18a and the points 18b and 18c of the semi-circular bottom 18e of a casing attached to the floor of the vehicle.

FIG. 18 shows a front view of a LH side seat equipped with a regulatory seat belt 13 the fixed point 13a of which is attached to the top of the beam 12; the position of the buckle point 13b is unchanged; the inertia reel 13c is attached beside the flange.

An optional seat belt 13d consisting of a strap identical to the regulatory seat belt allows a harness to be comprised the fixed point 13e of which is attached to the top of the backrest symmetrically to point 13a; its other end is equipped with length adjustment means and a buckle point identical to that of the regulatory belt.

For a vehicle equipped with lateral inflatable airbags, the seat can be placed on the RH side, the beam being found in the centre of the vehicle; this arrangement allows bilateral protection to be obtained.

FIG. 19a shows a side view of a set folded in vertical non-utilisation position.

FIG. 19a1 shows an enlarged view of the hinge lug 19 equipped with a sliding lock 19e the end 19f of which is engaged in the housing provided in the bearing abutment 19c.

FIG. 19b shows a side view of a seat with backrest in table position and locked rear attachments.

FIG. 19b1 shows an enlarged view of the end 19a of the hinge lug free to rotate on pin 18a attached to the floor and the groove 19b separating the abutment 19c allowing the retention of the seat in vertical position of abutment 19d which retains it in this position.

FIG. 20 shows a perspective view of the seat pan subassembly consisting of side beams 15 integrating the front section to which is attached the hinge lug 19 which can, if necessary, accommodate a vertical lock sliding in a rib. Said lock in this case replaces the bearing abutment 19d; a hole made in the bearing abutment 19c will allow the end to be accommodated thus ensuring the immobilisation of the seat.

The two flanges 4 are represented cut and each one comprises two holes 4k to take the attachment screws of the two mechanisms of known continuous or discontinuous types which are part of the backrest subassembly.

The two flanges are connected by the crossmember 14 equipped with safety belt inertia reel attachment support 14a.

FIG. 21 shows a perspective view of the end of a side beam 15 comprising two slots 15b allowing the fitting and the attachment of the flange and a hole 15a provided to accommodate the end of crossmember 14.

The module described is a technological breakthrough which can be used as a basis for the design of any seat with integrated seat belt and meets the safety, weight and price demands for mass distribution.

1. Module consisting of subassemblies used for the manufacture of specific frames of vehicle seats with seat belts with three or four integrated points, where the force exerted by the occupant of the seat is retained by the regulatory seat belt attached to the top of the beam the base of which is attached to a tube which in a concentric manner envelopes the bar by making a space comprised between the inside diameter of the tube and the outside diameter of the bar allowing the insertion of the energy absorption sleeves and their modulation and end-of-travel dogs which ensure the centering and the junction of the tube to said bar retained in rotation at each of its ends by two arms immobilised by two backrest position adjustment mechanisms, said backrest position adjustment mechanisms being comprised each of a flange supporting on one of their sides the retractable abutment acting as bearing surface for the arm, the bar being centred in the hole corresponding to the backrest hinge pin, the force transmitted by the arm and supported by the abutment is transmitted to the two flanges each retained by their claw in housings immobilising the module on the floor of the vehicle, two side beams ensuring the longitudinal retention of the flanges.

2. Module consisting of subassemblies according to claim 1, wherein the retractable abutment is attached to an end of the pin the other end of which is attached to the rod to which is attached by one of its ends a tension spring, an abutment attached to the flange acts as end-of-travel bearing surface at rest for the rod and holds the retractable abutment in a determined position allowing the memorised locking of the arm, the simultaneous unlocking of the two abutments is done by the synchronised pull handle of the two rods.

3. Module consisting of subassemblies according to claim 1 wherein the arm includes a lug comprising a bearing face bearing on a backrest play take-up elastic abutment.

4. Module consisting of subassemblies according to claim 1, wherein the horizontal claw comprises the end of the finger including a bearing face perpendicular to a horizontal radius the maximum length of which is comprised between the point located on the bearing face and the tangent to the bottom of semi-circular form acting as bearing surface for the retention pin which ensures the retention of the finger.

5. Module consisting of subassemblies according to claim 1, wherein the axis of the bar is offset by assembly flanges in relation to the hinge axis of the backrest mechanism corresponding to the bearing, the beam being attached to the tube by assembly flanges.

6. Module consisting of subassemblies according to claim 1, wherein the sleeve (No. 1) is welded by one of its ends at (B) to one of the ends of the tube and by its other end at (C) to the bar to immobilise the tube and the beam, the sleeve (No. 2) is welded by one of its ends at (B′) to the other end of the tube, its other end being attached to the mobile section of the rear impact modulation dog, the fixed section of the dog being welded at (C′) to the bar, wherein for the front impact the teeth of the dog are in contact in order to simultaneously drive the two sleeves, and for the rear impact of lower magnitude a space is made between the teeth of the dog allowing the setting into service of the sleeve (No. 2) to be deferred so that the sleeve (No. 1) can work alone through a predetermined angle.

7. Module consisting of subassemblies according to claim 1, wherein the damped stop sleeve (No. 3) is attached to an end-of-travel dog, the tube by point (B′) located between the rear impact modulation and the end-of-travel dogs drives them simultaneously, the position of the point (E) attaching the sleeve (No. 3) to the bar is calculated to distribute in equal parts the end-of-travel force on the two ends of the bar.

8. Module consisting of subassemblies according to claim 1, wherein the module consists of three energy absorption sleeves (Nos. 1′, 2′ and 4), two modulation dogs (A′-A′ and C-C) and two end-of-travel immediate stop dogs (B-B), for the front impact, wherein the teeth of the dogs (C-C and A′-A′) are offset allowing the sleeve (No. 1′) to initially work alone and as soon as they are in contact letting the sleeves (No. 4 and No. 2′) work simultaneously, wherein for the rear impact the sleeve (No. 1′) firstly works alone, secondly when the teeth of the dog (C-C) are in contact, the sleeve (No. 4) enters into action, thirdly when the teeth of the dog (A′-A′) are in contact, the sleeve (No. 2′) enters into action, fourthly the two end-of-travel immediate stop dogs enter into action.

9. Module consisting of subassemblies according to claim 1, wherein the two dogs (B-B) are attached to an end-of-travel damped stop sleeve.

10. Module consisting of subassemblies according to claim 1, wherein all the dogs (A-A B-B A′-A′ C-C) each consist of a mobile part and a fixed part connected by breakable points, comprising a subassembly consisting of a single part preferentially of tubular, cylindrical form and uniform section, the dogs being produced by simultaneous laser cutting of the fixed and mobile parts the relative axial and angular positions of which are fixed by the breakable points.

11. Module consisting of subassemblies according to claim 10, wherein the subassemblies comprising the dogs are separated by a laser cut allowing an indexing mark of their assembly direction to be made.

12. Module consisting of subassemblies according to claim 1, including a regulatory seat belt (13) the third integrated point (13a) of which is connected to the attachment point (12a) of the beam (12), the buckle point (13b) and the inertia reel (13c) being attached to the flanges (4), wherein a second belt (13d) comprising a harness is attached by its fixed point (13e) to the fourth integrated point of a beam (12′), its mobile point comprising a length adjustment and attachment buckle.

13. Module consisting of subassemblies according to claim 1, wherein a crossmember ensures the retention in correct position the two flanges and the attachment of the seat belt inertia reel support.

14. Module consisting of subassemblies according to claim 1, wherein the module has a hinge lug equipped with a lock sliding in a hole made in the end of the hinge lug, said lug comprising a head the position of which during the tilting of the seat will correspond to that of the hole made in the bearing abutment.

15. Module consisting of subassemblies according to claim 1, wherein the two side beams each comprise two slots allowing the fitting and the attachment of the flange and a hole provided to accommodate the end of the crossmember.
